(19) United States
(12) Patent Application Publication
(10) Pub. No.: US 2009/0019497 A1
(43) Pub. Date: Jan. 15, 2009

(54) SYSTEM FOR CONFIGURING SATELLITE COMMUNICATION SERVICES

(75) Inventors: SCOTT WHITE, AUSTIN, TX (US); RAMSEY KSAR, SAN JOSE, CA (US)

Correspondence Address: AKERMAN SENTERFITT, P.O. BOX 3188, WEST PALM BEACH, FL, 33402-3188, US

(73) Assignees: AT&T KNOWLEDGE VENTURES, L.P., RENO, NV (US); YAHOO! INC., SUNNYVALE, CA (US)

(21) Appl. No.: 11/775,349

(22) Filed: Jul. 10, 2007

(51) Int. Cl. H04N 7/20

(52) U.S. Cl. 725/68; 725/63

(57) ABSTRACT

A system for configuring satellite communication services is disclosed. A system that incorporates teachings of the present disclosure may include, for example, a portal having a controller element to detect an installation of a satellite media receiver operating in a satellite communication system. The installation of the satellite media receiver can be detected by way of a broadband port of said satellite media receiver when coupled to a local area network accessible by the portal. The controller element can also adapt at least a portion of said portal according to said installation. Other embodiments are disclosed.

### FIELD OF THE DISCLOSURE

The present disclosure relates generally to satellite communication services and more specifically to a system for configuring satellite communication services.

### BACKGROUND

Satellite receivers can now provide HDTV programming, parental controls, video on demand (VoD) services, digital video recording (DVR) services, and numerous other features that consumers can enjoy in the privacy of their home or office. These services, however, are not easily manageable remotely.

A need therefore arises for a system for configuring satellite communication services.

### BRIEF DESCRIPTION OF THE DRAWINGS

FIG. 1 depicts an exemplary embodiment of a satellite communication system;

FIG. 2 depicts an exemplary method operating in portions of the satellite communication system;

FIGS. 3-4 depict exemplary embodiments of a portal of the satellite communication system;

FIG. 5 depict another exemplary method operating in portions of the satellite communication system; and

FIG. 6 is a diagrammatic representation of a machine in the form of a computer system within which a set of instructions, when executed, may cause the machine to perform any one or more of the methodologies discussed herein.

### DETAILED DESCRIPTION

Broadly stated, embodiments in accordance with the present disclosure provide a system for configuring satellite communication services.

In a first embodiment of the present disclosure, a computer-readable storage medium in a Network Management System (NMS) can have computer instructions for receiving a notice of installation from a Residential Gateway (RG) coupled to the NMS by way of a communication system. The notice of installation can correspond to an installation of a satellite media receiver. The satellite media receiver can have a broadband port coupled to a Local Area Network (LAN) managed by the RG and a satellite receiver port for receiving satellite signals supplied by a satellite dish system. The satellite signals can be associated with satellite media services of a satellite communication system. The RG can detect the satellite media receiver when the broadband port is coupled to the LAN. The storage medium can further include computer instructions for directing a portal responsive to said notice of installation to create a derivative account for a subscriber associated with said satellite media receiver, and configure at least a portion of the derivative account according to information supplied in the notice of installation.

In a second embodiment of the present disclosure, a portal can have a controller element to detect an installation of a satellite media receiver operating in a satellite communication system. The installation of the satellite media receiver can be detected by way of a broadband port of said satellite media receiver when coupled to a LAN accessible by the portal. The controller element can adapt at least a portion of said portal according to said installation.

In a third embodiment of the present disclosure, a satellite media receiver can have a broadband port coupled to a LAN, and a satellite receiver port for receiving satellite signals supplied by a satellite dish system. The satellite signals can be associated with satellite media services of a satellite communication system. The satellite media receiver can further have a controller element to manage operations of the broadband port, the satellite receiver port, and to generate a notice of installation for a portal to adapt to an installation of said satellite media receiver responsive to detecting a coupling of the broadband port to the LAN.

In a fourth embodiment of the present disclosure, a gateway can have a controller element to manage a LAN, detect an installation of a satellite media receiver when a broadband port of said satellite media receiver is coupled to the LAN, and submit a notice of installation associated with the detected installation of the satellite media receiver for a portal to adapt to said installation.

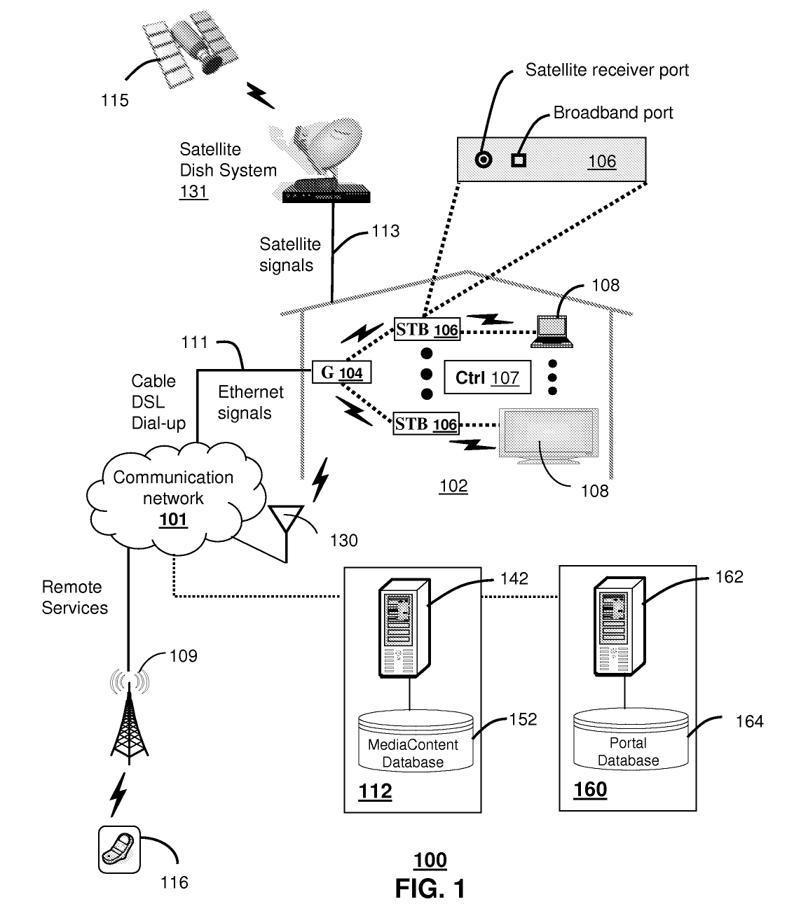

FIG. 1 depicts an exemplary embodiment of a satellite communication system 100. The satellite communication system 100 can comprise a satellite dish system 131 that delivers multimedia satellite services from one or more satellites 115 to a residence or commercial establishment (“building”) 102. The satellite communication system 100 can include a Network Manage System (NMS) 112 that can manage and detect installations in the building 102 of a gateway 104 and/or a satellite media receiver 106 such as Set-Top Box (STB). The NMS 112 can detect the gateway 104 and/or satellite media receiver 106 by means of the communication network 101.

The NMS 112 can comprise a controller element 142 and a memory or mass storage system 152. The controller element 142 can utilize common computing technologies (e.g., desktop computer, server, etc.) to manage use of available processing resources of the NMS 112 for executing one or more processes and to manage operation of a mass storage system 152. The mass storage system 151 can utilize common storage technologies (e.g., hard disk drives, flash memory, etc.) to store data in one or more databases.

The gateway 104 can be programmed to exchange messages with the NMS 112 over the communication network 101. The gateway 104 can also be used to distribute a portion of Ethernet signals 111 and satellite signals 113 to one or more STBs 106 for presenting satellite multimedia services to media devices 108 such as a computer, cell phone, portable music player, or analog or digital television (e.g., plasma TV). Alternatively, the STBs 106 can be coupled to the satellite dish system 131 and thereby receive the satellite signals 113 directly.

The satellite media receiver 106 can be supplied to subscribers by a satellite broadcast communications provider for purposes of delivering satellite media services to the media device 108. The delivery of said satellite program to the media devices 108 can be distributed by common wired or wireless means. A media controller 107 such as a remote controller can be programmed to control the satellite media receiver 106 and/or the media device 108. The media controller 107 can utilize common infrared or RF signaling technology to communicate with one or more of the aforementioned subsystems of the satellite communication system 100. The media controller 107 can also include a common display (e.g., LCD) for presenting a user interface (UI) for controlling operations of the satellite media receiver 106.

The satellite communication system 100 can utilize a portal 160 that can provide portal services to subscribers of the satellite communication system 100. The controller element 162 can utilize common computing technologies (e.g., desktop computer, server, etc.) to manage use of available processing resources of the portal 160 for executing one or more processes and to manage operation of a mass storage system 164. The mass storage system 164 can utilize common storage technologies (e.g., hard disk drives, flash memory, etc.) to store data in one or more databases.

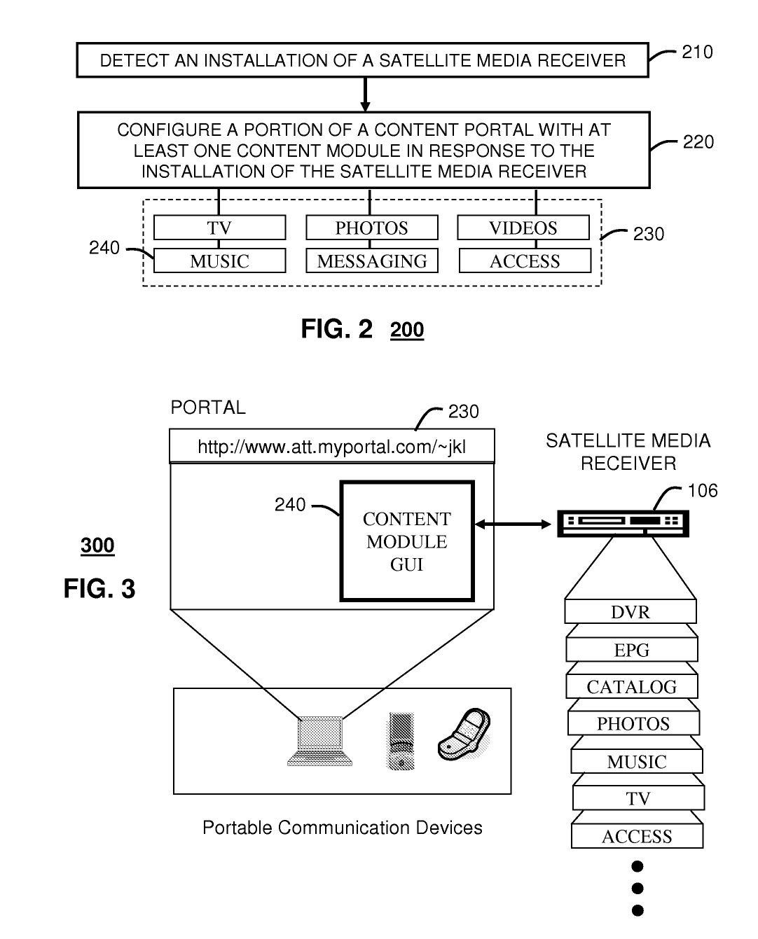

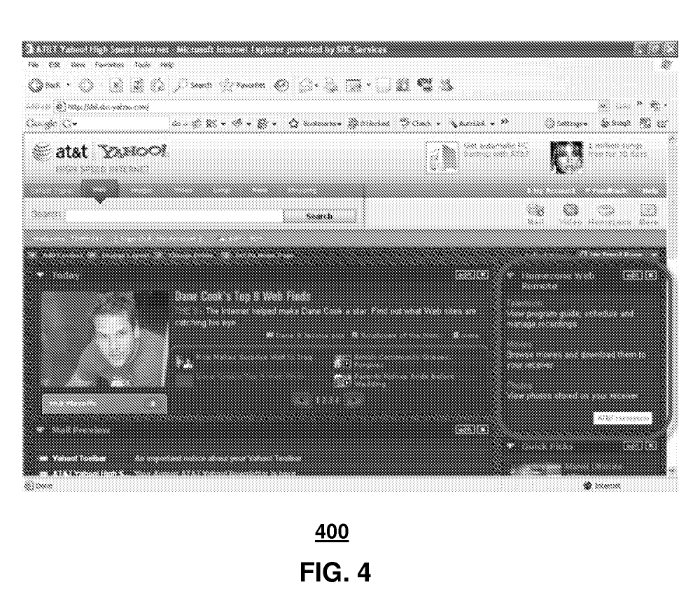

Referring to FIG. 2, a method 200 is depicted for adapting the portal 160 (see also FIG. 3) of the satellite communication system 100 responsive to an installation of a satellite media receiver 106 in said satellite communication system. It should be noted that the method 200 can be practiced with more or less steps than those shown. The portal 160 can present a website managed by the service provider of the satellite communication system 100 or by a third-party contracted by said service provider (e.g., yahoo.com, google.com, etc.—see FIG. 4). The portal 160 can be operated as a common web server interconnected to various subsystems of the satellite communication system 100, and accessible by a public internet service of an internet service provider (ISP) which for illustration purposes can be embodied in communication network 101.

The portal 160 can be programmed to establish a derivative account for each subscriber of the satellite communication system 100. Each derivative account can be selectively managed by subscribers using a unique login and password. The derivative account provides each subscriber of the satellite communication system 100 a customizable web access account which can be accessed using internet-capable communication devices such as cell phones and computers while in building 102, or while in transit using wireless communication techniques (e.g., WiMAX, WiFi, software defined radio, cellular communications such as CDMA EV/DO, GSM GPRS, UMTS, and so on).

With these principles in mind, in step 210, a subsystem of the satellite communication system 100 can be programmed by common means to detect an installation of the satellite media receiver 106 in building 102. A subsystem of satellite communication system 100 in the present context can mean one or more network elements of the satellite communication system of FIG. 1 such as the NMS 112, the gateway 104, the satellite media receiver 106 being installed, or combinations thereof.

For example, when a user first installs the satellite media receiver 106 in building 102, the gateway 104 can determine that a new satellite media receiver has been added to its network after power cycling said satellite media receiver. The gateway 104 can be programmed to transmit an installation notice to the NMS 112 which directs the portal 160 on installation procedures related to this event. In another arrangement, the satellite media receiver 106 can detect and report a self-installation to the gateway 104 which informs the NMS 112. In yet another arrangement, the portal 160 or the NMS 112 can be programmed to detect the installation of the satellite media receiver 106 by polling gateways 104 in buildings 102 for updates to their network.

At step 220, the NMS 112 can be programmed to direct the portal 160 to add a content module 240 in response to the installation detected in step 210. Alternatively, the portal 160 can be adapted with one or more content modules 240 as directed by the satellite media receiver 106, the gateway 104, or any other subsystem of the satellite communication system 100. It would be evident to an artisan of ordinary skill in the art that adaptation of one or more derivative accounts of the portal 160 can be managed by the portal, by one or more other subsystems of the satellite communication system 100, or combinations thereof.

A content module 240 can be selected by the portal 160 from a group of content modules stored in its database or some other storage device in the satellite communication system 100 (e.g., the database of the NMS 112). Content modules can serve the purpose of managing one or more functions of the satellite media receiver 106, one or more accessories coupled to the satellite media receiver (e.g., DVR, audio system, computing system, etc.), and/or one or more services supplied from or to the satellite media receiver. A content module can be used to present a specialized graphical user interface (GUI) in the form of selectable hypertext with a GUI button included in a general GUI (e.g., home page) of a derivative account of the portal 160. In the case where two or more subscribers are associated with the newly installed satellite media receiver 106 (e.g., two or more users sharing an STB in a multi-user household), one or more content modules 240 can be added to the derivate accounts of each subscriber.

A content module 240 can also represent a group of computer instructions executed by the portal 160 to control for example a built-in DVR function of a satellite media receiver 106. The content module 240 in this instance can provide the subscriber of the satellite media receiver 106 a GUI interface with selectable GUI controls for managing DVR functions remotely via their derivative portal account. In another embodiment, a content module 240 can have a GUI with selectable controls for managing personal media (e.g., family pictures or videos, etc.) stored in the satellite media receiver 106. In yet another embodiment, the content module 240 can have a GUI with selectable controls for managing music files stored in the satellite media receiver 106 or an accessory coupled thereto.

The GUIs of these content modules can provide additional controls for configuring file sharing privileges between subscribers. In another embodiment, the content module 240 can have a GUI with selectable controls for viewing an electronic programming guide (EPG), viewing video on demand (VoD) catalogs and selecting one or more satellite media programs for later viewing, adjusting parental controls, or managing other services supplied to or by the satellite media receiver 106.

A repository can be created to store any number of content modules 240 at the portal 160 or in a storage device of another subsystem in the satellite communication system 100 (e.g., the NMS 112). The portal 160 can thus present in step 220 one or more content modules 240 selected from this repository for the purposes of providing subscribers remote access for controlling and managing operations of any media subsystem in building 102 without physical co-location required. The content modules 240 can be predefined to address interoperability issues between different models of satellite media receivers 106 and accessories coupled thereto. A content module 240 therefore can provide configuration access to an underlying media function, operation, or service of satellite subsystems in building 102.

The gateway 104 can be configured to provide secure access to the portal 160 using a designated port for portal access, or an SSL, VPN, or like secure connection to the gateway. The gateway 104 can have a firewall feature to limit remote access to the satellite media receiver 106. The portal 160 can be provided a protected and limited communication link (“a pinhole”) through the gateway's firewall to the satellite media receiver 106. The opened communication channel through the gateway 104 to the satellite media receiver 106 allows for deployment of remote access applications that can be used to manage operations and services of the satellite media receiver according to the aforementioned content modules 240. The gateway 104 can also open IP ports for remote access applications associated with one or more content modules 240 to manage services, expose diagnostic information or perform automatic software updates.

A service provider of the portal 160 can therefore offer derivative accounts to manage telephone, satellite, broadband, Internet, or cable services supplied by the satellite communication system 100. A content module 240 as noted earlier can be automatically configured and placed in a user's derivative portal account in response to an installation of the satellite media receiver 106, or detection of an accessory (e.g., DVR) coupled to the satellite media receiver 106. The self-adaptation of the portal 160 removes the cumbersome task of requiring subscribers to manually configure their portal account for remote management of the satellite media subsystems in building 102.

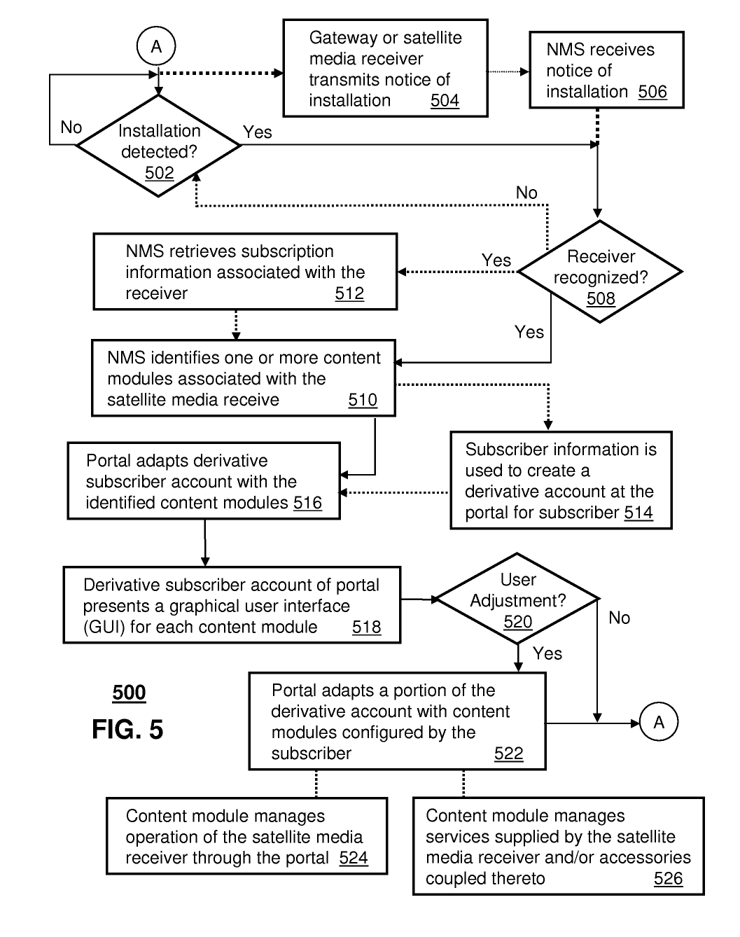

Referring to FIG. 5, an exemplary method 500 is presented for with more embodiments for directing a configuration of at least a portion of the portal 160. Method 500 begins with step 502 in which the NMS 112 detects an installation of the satellite media receiver 106 in building 102. The detection can occur from the NMS 112 polling the gateway 104 or from the satellite media receiver providing installation updates. Alternatively, at steps 504-506 the satellite media receiver 106 being installed can proactively partake in the detection step by generating a self-aware installation notice, or the gateway 104 can submit to the NMS 112 an installation notice upon detecting said installation.

At step 506, upon receiving the installation notice the NMS 112 can report the installation to systems managing content modules 240, provisioning systems of satellite communication system 100, and/or other subsystems of the satellite communication system requesting notification of a detected installation. Once the notice of installation has been received, at step 508, the NMS 112 checks whether it recognizes the satellite media receiver 106. The notice of installation can include an identification of the satellite media receiver 106 along with subscription information associated with a service supplied by, or to the satellite media receiver 106 along with accessories detected by the satellite media receiver 106 that can be controlled thereby. The identification can be a serial number, a physical address, a MAC address, a model number, an encrypted code, or any other signature mark of the satellite media receiver 106 and accessories coupled thereto. If the satellite media receiver 106 is not recognized, an error message can be generated by the NMS 112 which can be conveyed to a service agent of the satellite communication system 100. Following the error message, the NMS 112 returns to step 502 to monitor additional installations.

Upon recognizing the satellite media receiver 106, at step 508, the NMS 112 can identify at step 510 one or more content modules 240 compatible with the satellite media receiver 106, services associated therewith, and accessories coupled thereto. For example, a content module 240 can be selected by the NMS 112 for controlling DVR functions of the satellite media receiver 106 as previously mentioned. Another content module 240 can be selected by the NMS 112 for managing personal media files. Yet another content module 240 can be selected by the NMS 112 for viewing EPG and VoD catalogs, and so on.

In a supplemental embodiment, at step 512, the NMS 112 can also retrieve subscription information associated with the satellite media receiver 106. The subscription information can be retrieved from a provisioning system of the satellite communication system 100 that manages and records satellite media services subscribed to by each user of the satellite media receiver 106. The subscriber information can identify services currently available or offered to the satellite media receiver 106. With this information, at step 514, the NMS 112 can direct the portal 160 to create the derivative account based on known subscriber information.

At step 516, the portal 160 can be adapted with the one or more content modules 240 identified in step 510 responsive to the detected installation. The content modules 240 can be supplied to the portal 160 by the NMS 112. Alternatively, the content modules 240 can be identified by the NMS 112 and retrieved by the portal 160 from its database or a remote storage device as described earlier. At step 518, the portal 160 can be programmed to present one or more GUI elements for each content module 240 selected in step 510. Based on user preferences supplied by the subscriber or subscriber interactions detected by the portal 160 while the subscriber browses his or her account, the portal can be directed to remove, replace, or modify at least one of the content modules 240 configured automatically by the portal. The portal 160 can also receive a directive from the subscriber to add other content modules 240 selected by said subscriber from the portal as optional content modules. These content modules can be modules not automatically installed, but which the subscriber can select from a list presented by the portal 160 through the subscriber's derivative account to augment features for remotely accessing and managing the satellite media receiver 106, accessories coupled thereto, or other subsystems of satellite communication system 100.

Additionally, content modules can be customized in steps 520-522 by the subscriber if desired by common GUI controls supplied with said modules for adaptation according to user preferences. The subscriber can for example configure one or more of the content modules 240 according to adjustable settings, services, or features supplied by the content module. In another arrangement, the portal 160 can customize the content module 240 for presentation on different portable communication devices of the subscriber. For example, the portal 240 can be programmed to present a content module 240 with a different look and feel on a cell phone versus a laptop computer to account for to the display size and control disparities.

At step 522, the portal 160 can be adapted with the content modules 240 configured by the subscriber. The adaptation of the portal 160 can result from the content modules added in step 516 being removed, modified or supplemented with new content modules selected by the subscriber. In yet another arrangement, the portal 160 can support detachable GUIs associated with the content modules 240 thereby allowing the subscriber the flexibility to move said modules around in a web page of the subscriber's account. In such regard, the subscriber can customize their home web page.

From step 522, the portal 160 can provide a subscriber in step 524 remote access to operations of the satellite media receiver 106 using the content module 240. An operation of the satellite media receiver 106 can include broadcast channel programming, electronic program guide (EPG) viewing, media program catalog processing, media file processing, media on demand programming, parental control programming, and digital video recorder (DVR) programming, among other operational features which can be managed by way of the content module 240.

The content modules 240 can also manage in step 526 services supplied by the satellite media receiver 106, and/or one or more accessories coupled to the satellite media receiver. For example, an accessory can be a DVR, VCR, a portable music player, handheld personal digital assistant, home stereo, fax machine, or copier. A content module can be supplied in the portal 160 for each accessory managed through the satellite media receiver 106.

From these embodiments, it would be evident to an artisan with ordinary skill in the art that said embodiments can be modified, reduced, or enhanced without departing from the scope and spirit of the claims described below. For example, there are conceivably many other content modules 240 not described in the present disclosure which can be developed by the service provider of the satellite communication system 100 or the service provider of the portal 160 for controlling or managing operations and services supplied to or provided by the satellite media receiver 106.

Additionally, the portal 160 can be programmed to provide the subscriber a tool kit for developing customized content modules 240 that can perform tasks not yet conceived by service providers of the satellite communication system 100 or portal 160. In yet another arrangement, agents of the satellite communication system 100 can perform service updates to the satellite media receiver 106 without deploying field technicians. Service updates can involve enabling features which a subscriber has requested (e.g., DVR, HDTV, HBO, etc.). The service update can in turn prompt the satellite media receiver 106 to submit an installation notice to the gateway 104 or the portal 160 to inform it of these new services. That in turn can prompt the portal 160 to install a new set of content modules 240 to the derivative account of each subscriber associated with the satellite media receiver 106 in question to manage these new services.

These are but a few examples of modifications that can be applied to the present disclosure without departing from the scope of the claims. Accordingly, the reader is directed to the claims section for a fuller understanding of the breadth and scope of the present disclosure.

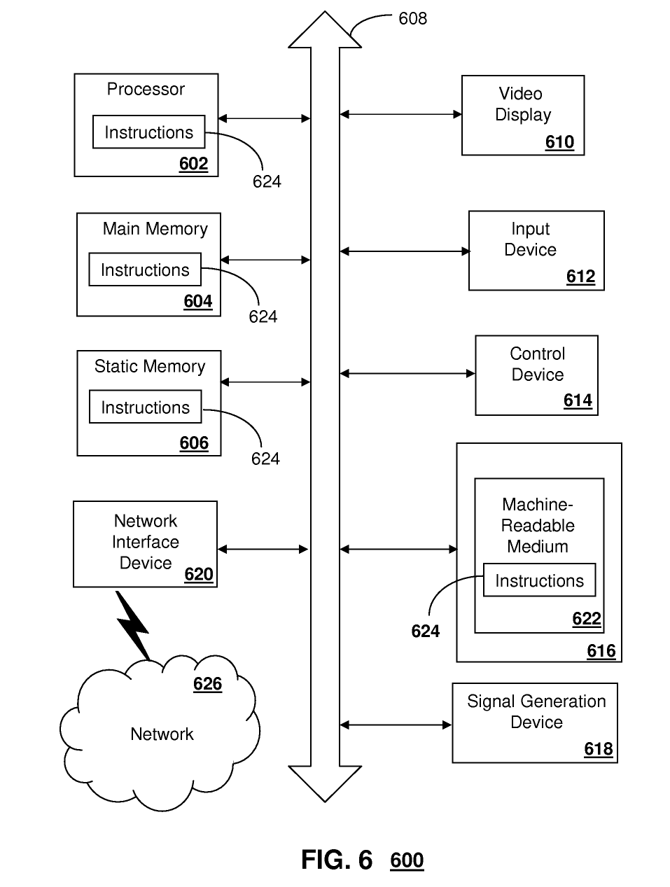

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a Network Management System (NMS), comprising computer instructions for:
receiving a notice of installation from a Residential Gateway (RG) coupled to the NMS by way of a communication system, wherein the notice of installation corresponds to an installation of a satellite media receiver, wherein the satellite media receiver comprises a broadband port coupled to a Local Area Network (LAN) managed by the RG and a satellite receiver port for receiving satellite signals supplied by a satellite dish system, wherein the satellite signals are associated with satellite media services of a satellite communication system, and wherein the RG detects the satellite media receiver when the broadband port is coupled to the LAN; and
directing a portal responsive to said notice of installation to:
create a derivative account for a subscriber associated with said satellite media receiver; and
configure at least a portion of the derivative account according to information supplied in the notice of installation.

2. The storage medium of claim 1, wherein the portal remotely manages operations of the satellite media receiver according to the subscriber's manipulation of a graphical user interface presented by the derivative account, wherein the portal manages operations of the satellite media receiver by establishing communications with the RG, and wherein the RG responsive to establishing communications with the portal provides the portal access to the broadband port of said satellite media receiver by way of the LAN.

3. The storage medium of claim 1, comprising computer instructions for directing the portal to configure at least the portion of the derivative account with at least one content module.

4. The storage medium of claim 3, wherein the at least one content module corresponds to at least one among a group of content modules for managing at least one among one or more functions of the satellite media receiver, one or more accessories coupled to the satellite media receiver, and one or more services supplied to or by the satellite media receiver.

5. The storage medium of claim 3, wherein the at least one content module is selected according to subscriber information associated with the satellite media receiver.

6. The storage medium of claim 3, wherein the at least one content module is selected according to a recognition of the satellite media receiver.

7. The storage medium of claim 1, wherein at least the portion of the derivative account comprises at least one among a group of selectable options comprising broadcast channel programming, electronic program guide (EPG) viewing, media program catalog processing, media file processing, media on demand programming, parental control programming, and digital video recorder (DVR) programming.

8. The storage medium of claim 1, wherein the installation of the satellite media receiver comprises one among a first time installation, an installation subsequent to the first time installation, a software update invoked by the satellite media receiver, a software update invoked by a subsystem of the satellite communication system, and a remote update applied to the satellite media receiver by an agent of the satellite communication system.

9. The storage medium of claim 1, wherein the satellite media receiver comprises a set-top box (STB) managed in part by a media controller for presenting media programs to one or more media devices.

10. The storage medium of claim 1, wherein the notice of installation comprises at least one among an identification of the satellite media receiver, and subscription information.

11. The storage medium of claim 1, wherein the LAN corresponds to at least one among a wireline LAN and a wireless LAN.

12. A portal, comprising a controller element to:
detect an installation of a satellite media receiver operating in a satellite communication system, wherein the installation of the satellite media receiver is detected by way of a broadband port of said satellite media receiver when coupled to a Local Area Network (LAN) accessible by the portal; and
adapt at least a portion of said portal according to said installation.

13. The portal of claim 12, wherein the controller element:
creates a derivative account corresponding to the adapted portion of said portal; and
manages operations of the satellite media receiver according to a subscriber's manipulation of a graphical user interface presented by the derivative account, wherein the controller element manages operations of the satellite media receiver by establishing communications with a Residential Gateway (RG) managing the LAN, wherein the RG responsive to establishing communications with the controller element provides the controller element access to the broadband port of said satellite media receiver by way of the LAN.

14. The portal of claim 12, wherein the controller element receives a notice of installation from at least one among the satellite media receiver, a gateway coupled to the satellite media receiver by way of the LAN, and a subsystem of the satellite communication system, and wherein the installation of the satellite media receiver comprises one among a first time installation, an installation subsequent to the first time installation, a software update invoked by the satellite media receiver, a software update invoked by a subsystem of the satellite communication system, and a remote installation update applied to the satellite media receiver by an agent of the satellite communication system.

15. The portal of claim 12, wherein the controller element configures at least the portion of the portal with at least one content module.

16. The portal of claim 15, wherein the controller element:
retrieves subscriber information associated with the satellite media receiver; and
selects the at least one content module according to said subscriber information.

17. The portal of claim 15, wherein the controller element:
recognizes the satellite media receiver; and
selects the at least one content module according to said recognition.

18. The portal of claim 12, wherein the controller element:
receives one or more selections applied to the portion of the portal; and
manages at least one among operations of the satellite media receiver, services supplied thereto by the satellite communication system, and accessories coupled to the satellite media receiver according to said one or more selections.

19. The portal of claim 15, wherein the at least one content module manages services supplied by at least one among the satellite communication system, the satellite media receiver, and one or more accessories coupled to the satellite media receiver.

20. The portal of claim 15, wherein the at least one content module corresponds to at least one among a group of content modules for managing a digital video recorder (DVR), an electronic program guide (EPG), a calendar, a collection of media files stored in the satellite media receiver, a storage system of the satellite media receiver, a media program catalog of the satellite communication system, a media on demand service of the satellite communication system, and parental controls of the satellite media receiver.

21. The portal of claim 15, wherein the controller element presents a graphical user interface (GUI) element for each of the at least one content module.

22. The portal of claim 15, wherein the controller element receives a directive to cause at least one of the content modules to be removed, replaced, or modified.

23. The portal of claim 15, wherein the controller element receives a directive to adapt at least the portion of said portal with one or more other content modules.

24. A satellite media receiver, comprising:
a broadband port coupled to a Local Area Network (LAN);
a satellite receiver port for receiving satellite signals supplied by a satellite dish system, wherein the satellite signals are associated with satellite media services of a satellite communication system; and
a controller element to manage operations of the broadband port, the satellite receiver port, and to generate a notice of installation for a portal to adapt to an installation of said satellite media receiver responsive to detecting a coupling of the broadband port to the LAN.

25. The satellite media receiver of claim 24, wherein the controller element submits the notice of installation to a gateway that manages the LAN, and wherein the gateway submits the notice of installation to one among the portal, and a media system that provides services to the satellite media receiver.

26. The satellite media receiver of claim 24, wherein the installation of the satellite media receiver comprises one among a first time installation, an installation subsequent to the first time installation, a software update invoked by the satellite media receiver, a software update invoked by a subsystem of a media system, and a remote update performed on the satellite media receiver by an agent of the media system.

27. The satellite media receiver of claim 24, wherein the portal is configured with at least one content module responsive to the notice of installation, wherein the at least one content module corresponds to at least one among a group of content modules for managing at least one among one or more functions of the satellite media receiver, one or more accessories coupled to the satellite media receiver, and one or more services supplied to the satellite media receiver, and wherein the satellite media receiver comprises a set-top box (STB) managed in part by a media controller for presenting media programs to one or more media devices.

28. A gateway, comprising a controller element to:
manage a Local Area Network (LAN);
detect an installation of a satellite media receiver when a broadband port of said satellite media receiver is coupled to the LAN; and
submit a notice of installation associated with the detected installation of the satellite media receiver for a portal to adapt to said installation.

29. The gateway of claim 28, wherein the controller element submits the notice of installation to one among a media system that provides services to the satellite media receiver, and the portal responsive to said detection.

30. The gateway of claim 28, wherein the portal is configured with at least one content module responsive to the notice of installation, and wherein the at least one content module corresponds to at least one among a group of content modules for managing at least one among one or more functions of the satellite media receiver, one or more accessories coupled to the satellite media receiver, and one or more services supplied to the satellite media receiver.

31. The gateway of claim 28, wherein the controller element receives the notice of installation from the satellite media receiver, wherein the installation of the satellite media receiver comprises one among a first time installation, an installation subsequent to the first time installation, a software update invoked by the satellite media receiver, a software update invoked by a subsystem of an satellite communication system, and a remote update performed on the satellite media receiver by an agent of the satellite communication system.
